(19) United States
(12) Patent Application Publication
(10) Pub. No.: US 2008/0151052 A1
(43) Pub. Date: Jun. 26, 2008

(54) INFRARED ILLUMINATOR WITH VARIABLE BEAM ANGLE

(75) Inventors: Bulent EREL, Roswell, GA (US); Chris W. HARDEN, Griffin, GA (US); Virgil L. HUNT, Snellville, GA (US); Peter G. SCHNEIDER, Decatur, GA (US); Raymond V. PAGANO, Stone Mountain, GA (US); James L. PFAFFENBERGER, Marietta, GA (US)

Correspondence Address: GARDNER GROFF GREENWALD & VILLANUEVA. PC, 2018 POWERS FERRY ROAD, SUITE 800, ATLANTA, GA, 30339, US

(73) Assignee: VIDEOLARM, INC., Decatur, GA (US)

(21) Appl. No.: 12/024,171

(22) Filed: Feb. 1, 2008

Related U.S. Application Data
(63) Continuation-in-part of application No. 11/933,599, filed on Nov. 1, 2007.
(60) Provisional application No. 60/863,912, filed on Nov. 1, 2006.

(51) Int. Cl. H04N 7/18; F21V 21/14

(52) U.S. Cl. 348/143; 362/418; 348/E07.085

(57) ABSTRACT

An infrared surveillance system including a first member with a first infrared light source mounted thereto, and a second member with a second infrared light source mounted thereto. The second member is positionally adjustable relative to the first member. The surveillance system also includes an infrared camera in operative communication with at least the second member to vary an illumination field provided by the first and second light sources depending on the camera's field of view. The surveillance system also includes at least one controller for varying the output intensity of the light sources.

### CROSS-REFERENCE TO RELATED APPLICATION

This application is a continuation-in-part of U.S. Non-Provisional patent application Ser. No. 11/933,599, filed Nov. 1, 2007, which claims the priority benefit of U.S. Provisional Patent Application Ser. No. 60/863,912, filed Nov. 1, 2006. These applications are hereby incorporated herein by reference in their entireties for all purposes.

### TECHNICAL FIELD

The present invention relates generally to illuminators and surveillance systems, and more particularly, to a variable beam angle infrared illuminator used in conjunction with infrared image capturing and surveillance technology.

### BACKGROUND OF THE INVENTION

Infrared cameras are able to acquire images in low or almost no light circumstances. Therefore, infrared cameras have long been used in the fields of night-vision systems, surveillance, military operations, and wildlife photography. In many instances, an infrared illuminator is used in combination with such cameras to project infrared light on a target area to successfully capture an image. The infrared light projected by the illuminator is reflected back from objects in the target field and then captured by the camera.

Known infrared illuminators, however, are not as versatile as might be desired, and often require a user to purchase and install different types of illuminators to provide different illumination field widths and/or ranges to satisfy a particular application. For example, separate infrared illuminators may provide 30-degree, 45-degree, or 60-degree field widths. If a user wishes to vary the field width or illumination range, a different type of illuminator must be provided. This is often not feasible or practical and can lead to inefficiencies and/or less than optimal illumination performance. Also, distributors, sellers and/or installers may need to stock multiple types of illuminator units for applications requiring different fields and/or ranges of illumination, which can result in availability problems and inefficiencies.

Thus it can be seen that needs exist for continuing improvement in the field of illumination. It is to the provision of an illuminator meeting these needs and others that the current application is primarily directed.

### SUMMARY OF THE INVENTION

In example embodiments, the present invention is an infrared surveillance system including an illuminator having a first member with a first infrared light source mounted thereto, and a second member with a second infrared light source mounted thereto. The second member is positionally adjustable in relation to the first member. The surveillance system optionally also includes an infrared camera in operative communication with at least the second member to vary an illumination field provided by the first and second light sources depending on the camera's field of view. The surveillance system also includes at least one controller for varying the output intensity of the light sources.

In another aspect, the present invention is an infrared surveillance system including an illuminator having a fixed panel, a pivoting panel, a positional adjustment mechanism, and a camera. The fixed panel includes a first light source mounted thereon. The pivoting panel is hingedly connected to the fixed panel and has a second light source mounted thereon. The positional adjustment mechanism varies the position of the pivoting panel in relation to the fixed panel such that a beam of light projected by the first and second light sources can be modified between a wide beam and a narrow beam. The camera is mounted within an opening in one of the fixed panel and pivoting panel and the camera is variable between a low zoom setting and a high zoom setting. The light sources project the wide beam when the camera is in the low zoom setting and the narrow beam when the camera is in the high zoom setting.

In another aspect, the present invention is a surveillance system including an infrared illuminator and an infrared camera. The illuminator includes a first infrared light source, a second infrared light source, and a positional adjustment mechanism. The second light source is positionally adjustable relative to the first light source. The positional adjustment mechanism varies the position of the second light source in relation of the first light source such that a field of infrared light projected by the first and second light sources can be modified between a first illumination field and a second illumination field. The camera has a first zoom setting and a second zoom setting, and communicates with the infrared illuminator whereby the illuminator projects the first illumination field when the camera is in the first zoom setting and projects the second illumination field when the camera is in the second zoom setting.

In still another aspect, the present invention is an illuminator including a first light source, a second light source, and a control mechanism whereby the second light source is positionally adjustable relative to the first light source. The illuminator receives a signal corresponding to the field of view of an onboard or external surveillance camera, and the control mechanism varies the beam of light output by the illuminator in response to the input signal.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view of an illuminator according to an example embodiment of the present invention.

FIG. 2 shows the illuminator of FIG. 1 with its housing opened and internal components partially withdrawn from the housing.

FIG. 3 is a rear perspective view of internal components of the illuminator of FIG. 1 shown removed from the housing.

FIG. 4a shows internal components of the illuminator of FIG. 1 adjusted to a 60° beam angle of illumination.

FIG. 4b shows internal components of the illuminator of FIG. 1 adjusted to a 30° beam angle of illumination.

FIG. 5a is an external view showing adjustment of the illuminator of FIG. 1 to a 60° beam angle of illumination.

FIG. 5b is an external view showing adjustment of the illuminator of FIG. 1 to a 30° beam angle of illumination.

FIG. 6a is a light pattern showing the field of illumination of an example embodiment of an illuminator according to the present invention, at a 60° beam angle.

FIG. 6b is a light pattern showing the field of illumination of an example embodiment of an illuminator according to the present invention, at a 30° beam angle.

FIG. 7 shows an illuminator according to another form of the present invention incorporating an onboard surveillance camera.

FIG. 8 is a rear perspective view of internal components of the illuminator of FIG. 7, shown removed from the housing.

FIG. 9 shows an illumination system according to another form of the present invention wherein an illuminator is in communication with a surveillance camera.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

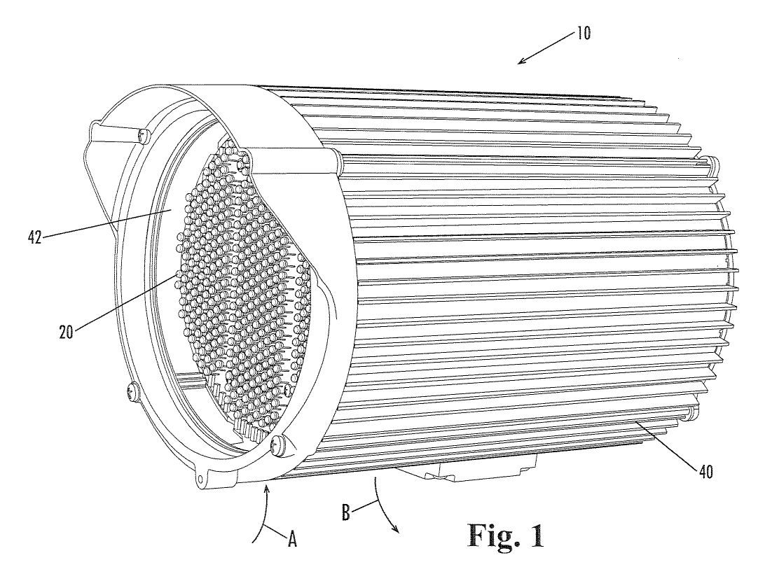

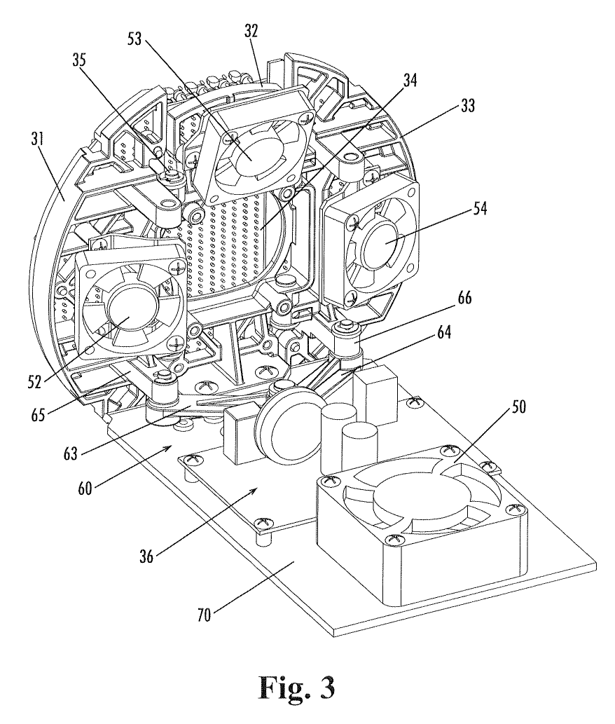

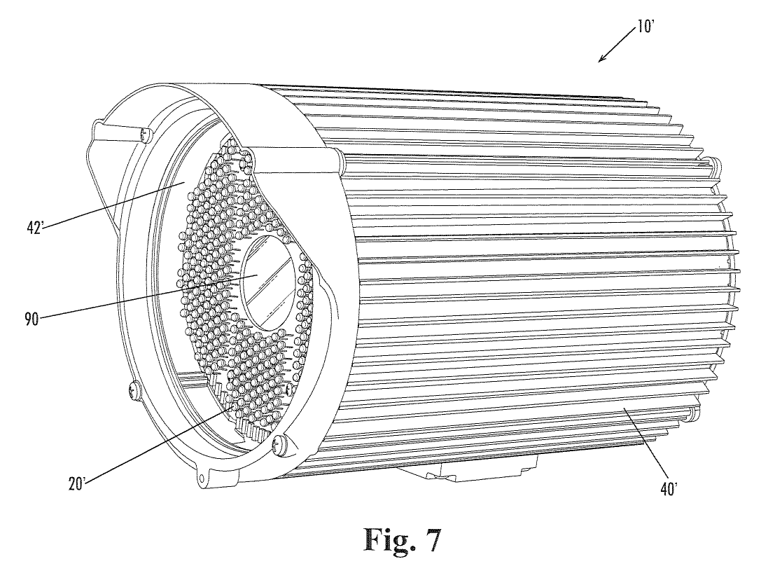

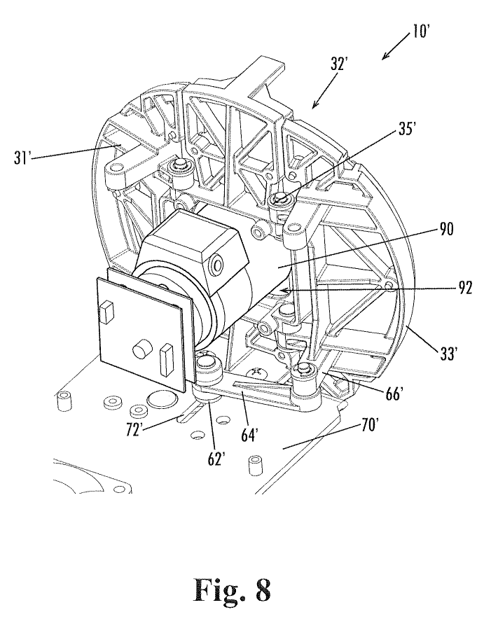

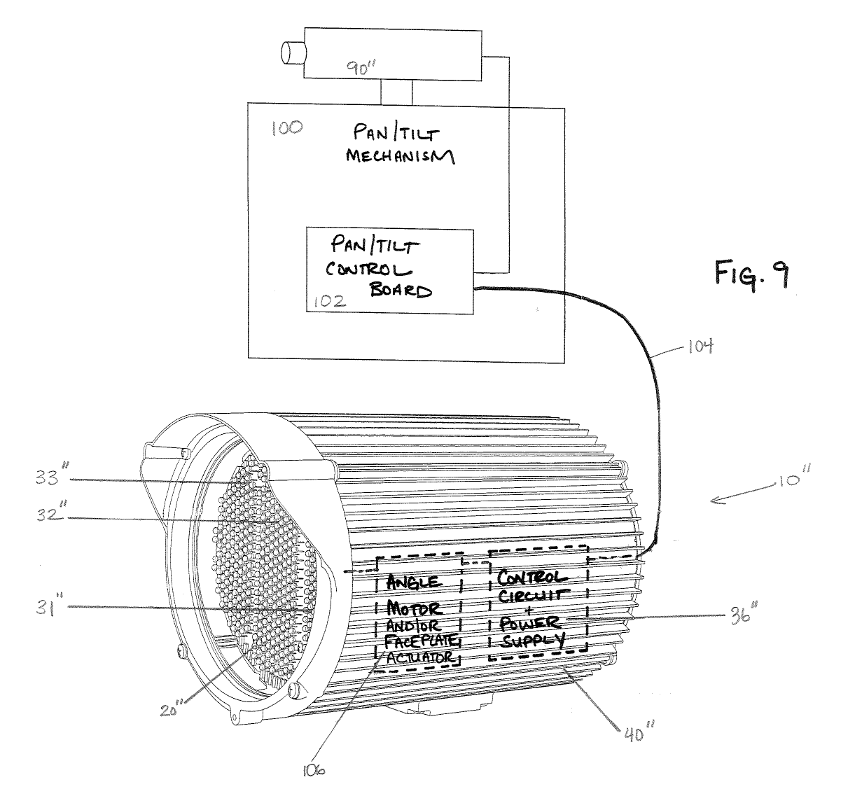

With reference now to the drawing figures, FIGS. 1-9 depict an illuminator 10, 10′, 10″ according to example embodiments of the present invention. The illuminator 10, 10′, 10″ of the present invention illuminates a field with light and optionally includes an on-board camera (shown in the embodiment of FIGS. 7 and 8, described below) for capturing both still and/or moving images, for example, for display and/or recording in remote surveillance applications. Alternatively or additionally, a separate camera is used in combination with the illuminator (shown in the embodiment of FIG. 9, described below).

In example embodiments, the illuminator 10 utilizes one or more light sources that only project wavelengths of light in the infrared (IR) spectrum (750 nm-1 mm), and do not emit light in the visible spectrum (roughly 400-700 nm), for use in combination with a camera suited for capturing images illuminated with infrared light. In other embodiments, the illuminator 10 can emit both infrared and visible light, visible light only, and/or light of other wavelengths. The illuminator 10 comprises at least two light sources, wherein at least one light source is mounted to each of two or more carriers or faceplates, at least one of which is positionally adjustable relative to another to vary the range and/or field of illumination. In the depicted embodiment, a plurality of infrared light emitting diode (LED) light sources 20 are mounted to each of three faceplates 31, 32, 33. In alternative embodiments, other infrared and/or visible light sources such as floodlights, spotlights, or other types of lighting arrangements can be used in place of, or in conjunction with, the LEDs 22. The LEDs are preferably spaced apart from each other on the faceplates at distances that provide suitable performance, depending on factors such as the required application of the illuminator, the intensity of the LEDs, and amount of heat generated by such. In example embodiments, the LEDs are spaced apart from each other, both horizontally and vertically, at distances of approximately 0.085 inches.

The illuminator 10 further comprises a housing 40 for receiving the faceplates or carriers 31, 32, 33 and light sources 20 therein, and at least one fan 50 for cooling the illuminator and its components by delivery of targeted cooling air flow(s) through and within the housing. The illuminator 10 further comprises an illumination angle adjustment mechanism 60 for adjusting the position of one or more faceplates relative to one another, which is described in greater detail below. The LEDs 20 or other light sources are connected to electronic panel portions 34 of each of the faceplates 31, 32, 33, and are powered and controlled by electronics 36 on a circuit board mounted to a mounting plate 70 within the housing 40. Optionally, the control circuitry 36 includes a switch or other electronic power controller for varying the current and/or the voltage delivered to the light sources to provide two or more power settings (such as high, medium, and low) for additional control of the range or intensity of illumination delivered. The mounting plate 70 is preferably slidably or otherwise retractably mounted within the housing 40 for access during maintenance or installation.

In the depicted embodiment, two adjustable outer faceplates (31, 33) are pivotally connected to a fixed center faceplate 32 for varying the output direction of the infrared light generated by light sources on the respective faceplates, and thereby varying the beam angle of illumination. In example embodiments, four hinges 35 (two per side) connect the outer faceplates to the center faceplate, and enable pivotal movement of the outer faceplates in relation to the center faceplate (in alternate embodiments, more or fewer hinges or other couplings can be utilized). Also, while the depicted embodiments comprise angularly adjustable side faceplates for varying the horizontal field of illumination, the invention likewise includes embodiments having adjustable top and/or bottom faceplates for varying the vertical field of illumination. In various alternative forms of the invention, one or more fixed faceplate(s) are provided with one, two, three or more adjustable faceplates positioned in angularly adjustable relation thereto. For example, a central faceplate may be provided with four outer faceplates, one hingedly attached at the top, bottom, left and right edges of the central faceplate. Alternatively, two or more adjustable faceplates may be provided without a fixed faceplate, for example in the form of first and second pivoting faceplates connected on either side of a central hinge.

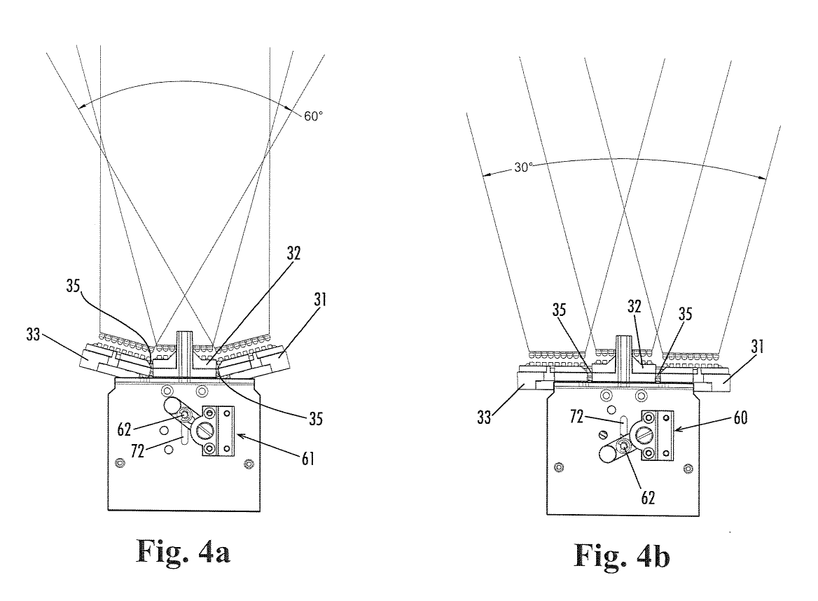

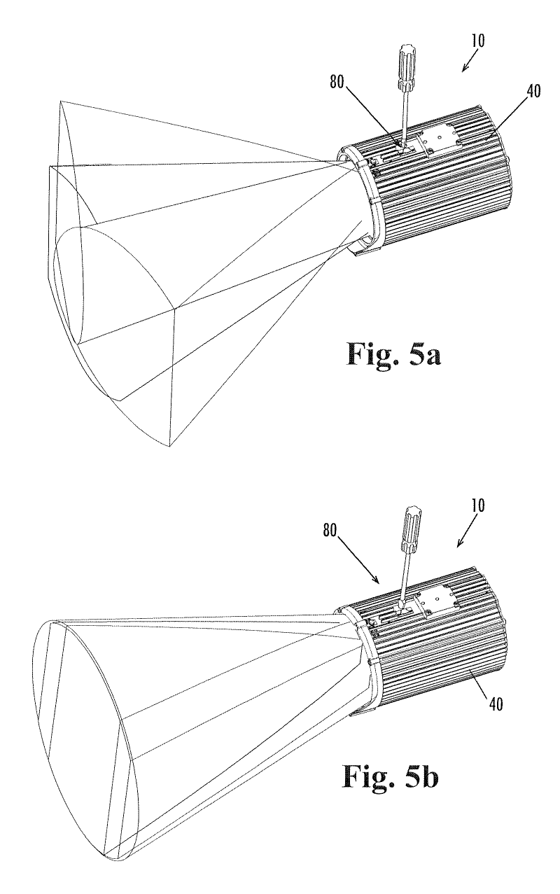

The illuminator 10 further comprises a faceplate position adjustment mechanism 60 enabling angular adjustment of the outer faceplates (31, 33) relative to the center faceplate 32, preferably from outside of the housing 40. For example, as seen best with reference to FIGS. 4 and 5, the present invention eliminates the need for different infrared illuminators of differing ranges or output patterns, by enabling user adjustment of the beam angle of the infrared light output to vary the width or field, the range, and/or the intensity of the illumination provided. Example embodiments of the present invention allow a user to adjust the output beam angle of the infrared illumination between about 30 degrees and about 60 degrees. For example, for LEDs 20 having a natural field angle of 30°, it has been found that a 60° spread or beam angle (FIGS. 4a and 5a) allows for suitable illumination of a wider field, a lower illumination intensity, and/or a closer range; whereas a 30° spread or beam angle (FIGS. 4b and 5b) allows for suitable illumination of a narrower field, a higher illumination intensity, and/or a longer range. The illuminator 10 is preferably configured and installed with the pivot axes of the hinged connections between the faceplates generally vertically oriented, such that angular adjustment of the faceplates varies the horizontal spread of illumination. Alternatively, the angular orientation of the faceplate adjustment axes may vary depending on the desired application.

In example embodiments, the faceplate position adjustment mechanism 60 comprises a pin 62 or other member slidably coupled within a slot 72 formed in the mounting plate 70, and one or more linkages pivotally connected to the outer faceplates 31, 33 as seen best in FIGS. 4a and 4b. In such an arrangement, a user can manually move the pin coupling 62 forwards and backwards in the slot 72 in the mounting plate 70 to vary the output illumination beam angle. The slot 72 is generally positioned perpendicular to the fixed faceplate 32. The pin coupling 62 is pivotally coupled to elongated linkage members 63, 64, which in turn are pivotally coupled to yokes 65, 66 on each of the adjustable outer faceplates 31, 33. In this manner, sliding the pin coupling 62 rearward in the slot (FIG. 4b), away from the front of the illuminator, rotates the outer faceplates 31, 33 outwards, thereby decreasing the illumination beam angle of the infrared field. Conversely, sliding the pin coupling 62 forward in the slot (FIG. 4a), towards the front of the illuminator 10, pivots the outer faceplates inwards, thereby increasing illumination beam angle of the infrared field. In example embodiments, a screwdriver slot 80 is provided through the housing for manually operating the adjustment mechanism 60. In other embodiments, a motorized or solenoid operated actuator is provided with a local or remote switch or controller, or various other manual or automatic adjustment mechanisms are provided to permit adjustment of the angle of illumination. The screwdriver slot 80, or other means of adjustment is preferably indexed and labeled to permit a user to accurately adjust the illumination angle to a desired setting. In example embodiments, 30°, 45° and 60° field angle settings are provided, and are marked with setting indicia. In various alternate forms of the invention the outer faceplates can be adjusted to any angular orientation between aligned with the control faceplate (0°) and perpendicular to the central faceplate (90°) in the forward and/or backward direction.

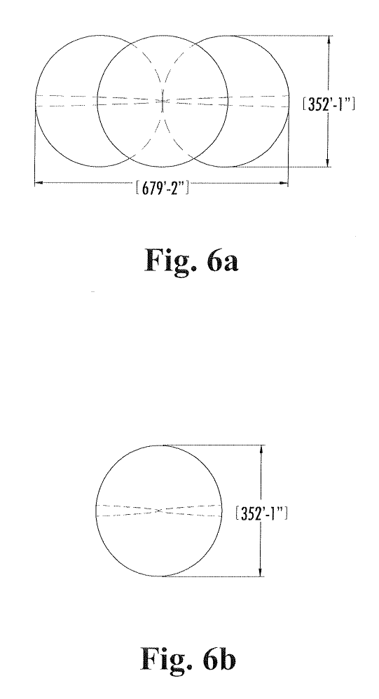

FIGS. 6a and 6b show example patterns of illumination output at 200 meters from the illuminator 10 at 60° (FIG. 6a) and 30° (FIG. 6b) illumination angles. The 30° adjustment provides for a narrower beam or field (about 352 feet in diameter), but a higher intensity or greater range; while the 60° adjustment allows for a wider beam or field (about 679 feet wide by about 352 feet high), but a lower intensity or shorter range. Similar light distribution patterns result when the beams are examined at different ranges. For example, at 100 meters, example heights of the beams are approximately 176 feet, and example widths of the beam are approximately 339 feet at the 60° adjustment and approximately 176 feet at the 30° adjustment.

In order to dissipate heat generated by the LEDs 22 and the electronic circuitry, one or more (four are depicted) fans 50, 52, 53, and 54 are used to circulate cooling air through the housing to remove heat from the illuminator 10, and/or to draw air across the LED leads for heat dissipation. In the depicted embodiment, three fans (52, 53, 54) are positioned behind the faceplates to blow or draw air over and across the LED leads, and fan 50 circulates cooling air through the housing. In example embodiments, each faceplate 30 has at least one fan attached to and positioned behind the faceplate. In alternate embodiments, more or fewer fans 50 are used in differing patterns. These fans are preferably oriented at about 30°-45° angles relative to the faceplates to provide a distributed airflow pattern. For example, fan 53 can be mounted at the top of the center faceplate 32, and angled downwardly at about 45°, and fans 52 and 54 mounted to the middle of side faceplates 31, 33, and angled inwardly at about 30°. In addition to the faceplate fans, at least one larger intake or discharge fan 50 is preferably positioned adjacent an opening through the housing 40, and preferably mounted to the mounting plate 70, to draw in fresh air from outside the housing 40 or to exhaust hot air out of the housing. In the depicted embodiment, fresh air intake A is delivered through one or more openings in a forward portion of the housing 40 beneath or in front of the LED faceplates, and hot exhaust air B is discharged through one or more openings in a rearward portion of the housing 40 behind the LED faceplates. In this manner, the fan(s) circulate air across the front and rear surfaces of the LED faceplates, and between adjacent LEDs for cooling. In alternate forms of the invention, one or more openings or vents are optionally provided through the faceplates for allowing fresh air to be draw in through the faceplates.

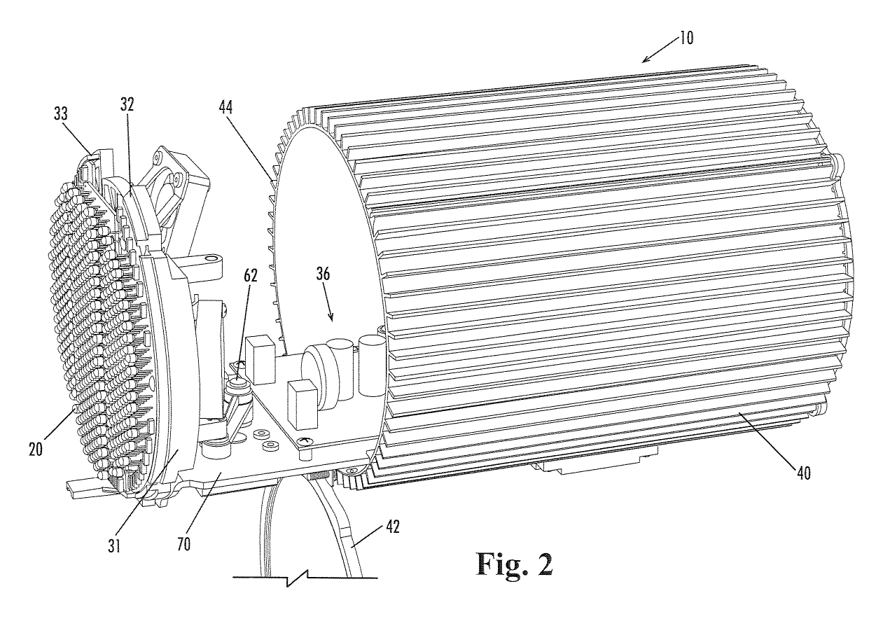

In example embodiments, the housing 40 is generally cylindrical in shape and adapted to receive the LEDs 22, faceplates, fans 50, and accompanying electrical components therein in a weatherproof enclosure. The housing 40 can be fabricated from various materials including, but not limited to, metal, plastic, rubber, or a combination thereof. In order to further cool the illuminator, the housing 40 optionally includes ridges or fins 44 for dissipating internal heat through convection with the surrounding air. In alternate embodiments, the shape of the housing is conical, rectangular, spherical or cubic, or otherwise configured. The housing 40 preferably comprises a clear glass or plastic lens 42 mounted within a front cover portion of the housing for protecting and transmitting light from the LEDs, and/or to allow a user to focus the infrared light output. The front cover portion of the housing is preferably removable for access to internal components, as seen in FIG. 2.

In embodiments having a circular housing cross-section, the fixed faceplate and the one or more outer faceplates preferably combine to have a generally circular outer profile sized to be closely received within the outer housing. For example, each of the outer faceplates in the depicted embodiment have profiles in the form of a circular segment divided from the fixed center faceplate by two parallel chords spaced equidistant from the central vertical diameter of the overall circular faceplate array. In alternate embodiments, a generally square or rectangular overall faceplate array comprising two or more rectangular faceplates are received within a housing having a generally square or rectangular cross-section. In example forms of the invention, each faceplate has approximately equal width and/or approximately equal surface area, such that each faceplate may carry about the same number of LEDs.

FIGS. 7 and 8 show another embodiment of an illuminator 10′ according to the present invention, equipped with an onboard infrared camera 90, to capture images under illumination by the illuminator. Signals corresponding to the image are transmitted by cable or wireless connection to a local or remote monitor or viewing station, and/or to a recording device (unshown). In example embodiments, the camera 90 is mounted in an opening 92 formed through the center of the fixed middle faceplate 32′, such that the camera's field of view is coaxially aligned with the illuminator's field of illumination. Other components of the illuminator 10′ are substantially like corresponding components of the above described embodiment, and are indicated with corresponding reference numbers with a prime (′) designation.

In further embodiments, the camera used in connection with the illuminator optionally includes a zoom lens for permitting the camera to vary its focal distance and better capture images at different field lengths. The zoom lens can be automatically controlled by the internal circuitry of the camera/illuminator or can be remotely controlled by a user. Alternatively, the zoom lens of the camera receives focal instructions from a motion detector or other sensor to focus on a particular subject. In such embodiments, the side faceplates of the illuminator operate in automated cooperation with the zoom camera to optimize illumination at the field length that corresponds to the focal distance of the camera. As the camera lens changes its focal distance, a signal is communicated to the illuminator's control circuitry to modify the output angle of the infrared light to create an optimal field of illumination for the camera. The automated movement of the side faceplates to accommodate the focal distance of the camera lens can be controlled, for example, by a motorized and/or solenoid operated actuator. In further example embodiments, the intensity of the infrared light output from the light sources of the illuminator is varied to accommodate the zoom properties of the camera. For example, when the camera lens is in a wide-angle mode, the illuminator illuminates a wide beam field with low infrared light output to substantially illuminate the lens field and to avoid overloading the camera's sensors (too much light may cause a white-out effect on the camera's imaging sensors). And when the camera is in full zoom mode the illuminator 10′ adjusts the side faceplates to produce a narrow beam field coupled with high intensity output, such that the lens field is adequately illuminated at the focal distance of the lens.

The present invention can also comprise an illumination/imaging retrofit system or kit, as shown in example form in FIG. 9. In such embodiments, an illuminator 10″ is paired with at least one external infrared camera 90″, and includes a connection port or other receiver for receiving a signal corresponding to a state of the camera and varying the output illumination in response thereto. The camera 90″ includes a pan and tilt mechanism 100 and/or a zoom lens for modifying the viewing field of the camera. The pan and tilt mechanism 100 includes a motor or other actuator for manipulating the pan and tilt orientation of the camera 90″. The camera 90″ is controlled via control circuitry 102 located within the pan/tilt body 100 or externally for varying the pan, tilt, and/or zoom of the camera's lens. The camera 90″ is in communication with the illuminator's control circuitry and/or power supply 36″ through at least one communication cable 104 (as seen in the drawing figure) and/or via a remote/wireless connection, and outputs a signal corresponding to a camera state such as the field of view, zoom position, pan and/or tilt angle, etc. The illuminator 10″ cooperates with the camera 90″ to properly illuminate the camera's viewing field and/or output the optimal intensity of infrared light by varying the power to the light sources 20″ in response to the field of view or other state of the camera. Additionally or alternatively, the illuminator 10″ also includes a motorized and/or solenoid operated actuator 106 to control the angular positioning of the side faceplates 31″, 33″ in order to create the optimal illumination field to complement the camera's zoom settings. Other components of the illuminator 10″ are substantially like corresponding components of the above described embodiments, and are indicated with corresponding reference numbers with a double prime (″) designation.

While the invention has been described with reference to preferred and example embodiments, it will be understood by those skilled in the art that a variety of modifications, additions and delections are within the scope of the invention, as defined by the following claims.

What is claimed is:

1. An infrared surveillance system comprising:
a first member having a first infrared light source mounted thereto;
a second member having a second infrared light source mounted thereto, the second member being positionally adjustable relative to the first member; and
an infrared camera in operative communication with at least the second member, to vary an illumination field provided by the first and second light sources depending on the camera's field of view.

2. The infrared surveillance system of claim 1, further comprising at least one controller for varying the output intensity of the light sources.

3. The infrared surveillance system of claim 2, wherein the at least one controller effects communication between the second member and the camera.

4. The infrared surveillance system of claim 2, further comprising a positional adjustment mechanism for varying the position of the second member in relation to the first member such that a field of infrared light projected by the first and second infrared light sources can be modified.

5. The infrared surveillance system of claim 4, wherein the field of infrared light illuminates substantially the entire field of view of the camera.

6. The infrared surveillance system of claim 4, wherein the camera is adapted to capture images in a first lens field and a second lens field, wherein the field of infrared light is variable between a first position corresponding to the first lens field and a second position corresponding to the second lens field, and wherein the positional adjustment mechanism automatically varies the position of the second member in relation to the first member, such that the field of infrared light is in the first position when the camera is adapted to capture images in the first lens field and the second position when the camera is adapted to capture images in the second lens field.

7. The infrared surveillance system of claim 6, wherein the output intensity of the light sources is variable between a low power output and a high power output, and wherein the at least one controller applies the low power output when the camera is adapted to capture images in the first lens field and the high power output when the camera is adapted to capture images in the second lens field.

8. The infrared surveillance system of claim 4, wherein the positional adjustment mechanism varies the position of the second member in relation to the first member to generate illumination beam angles of between 30 degrees and 60 degrees.

9. The infrared surveillance system of claim 4, wherein the positional adjustment mechanism is a motorized actuator.

10. The infrared surveillance system of claim 9, wherein the motorized actuator is regulated by the at least one controller.

11. A surveillance system comprising:
a fixed panel having a first light source mounted thereon;
a pivoting panel hingedly connected to the fixed panel and having a second light source mounted thereon;
a positional adjustment mechanism for varying the position of the pivoting panel in relation to the fixed panel such that a beam of light projected by the first and second light sources can be modified between a wide beam and a narrow beam; and
a camera mounted within an opening in one of the fixed panel and pivoting panel, the camera being variable between a low zoom setting and a high zoom setting;
wherein the light sources project the wide beam when the camera is in the low zoom setting and the narrow beam when the camera is in the high zoom setting.

12. The surveillance system of claim 11, wherein the output of the light sources is variable between a low intensity output and a high intensity output.

13. The surveillance system of claim 12, wherein the output of the light sources is the low intensity output when the camera is in the low zoom setting and the high intensity output when the camera is in the high zoom setting.

14. The surveillance system of claim 11, wherein the positional adjustment mechanism is a motorized actuator.

15. The surveillance system of claim 11, wherein a controller effects communication between the camera and the positional adjustment mechanism.

16. The surveillance system of claim 11, wherein the fixed panel, the pivoting panel, and the camera are enclosed within a housing.

17. A surveillance system comprising:
an infrared illuminator comprising a first infrared light source, a second infrared light source positionally adjustable relative to the first light source, and a positional adjustment mechanism for varying the position of the second light source in relation to the first light source such that a field of infrared light projected by the first and second light sources can be modified between a first illumination field and a second illumination field; and
an infrared camera in communication with the infrared illuminator, the infrared camera being adjustable between a first field of view and a second field of view;
wherein, the illuminator projects the first illumination field when the camera is in the first field of view and the second illumination field when the camera is in the second field of view.

18. The surveillance system of claim 17, wherein the illuminator further includes a controller for varying the output intensity of the light sources between a low power mode and a high power mode.

19. The surveillance system of claim 18, wherein the light sources are in low power mode when the camera is in the first field of view and high power mode when the camera is in the second field of view.

20. The surveillance system of claim 17, wherein the positional adjustment mechanism is a motorized actuator regulated by the camera.

21. The surveillance system of claim 17, further comprising an actuator for regulating the pan and tilt of the camera.

22. An illuminator comprising:
a first light source;
a second light source being positionally adjustable relative to the first light source; and
a positional adjustment mechanism for varying the position of the second light source in relation to the first light source such that a beam of light projected by the first and second light sources can be modified in response to an input signal from a camera.

23. The illuminator of claim 22, wherein the input signal is received from an internal camera.

24. The illuminator of claim 23, wherein the input signal is received from an external camera.

25. A variable output illuminator comprising:
at least one light source; and
control means for varying the output of the at least one light source in response to a signal corresponding to a state of a camera.
